(19) United States
(12) Patent Application Publication
(10) Pub. No.: US 2004/0121879 A1
(43) Pub. Date: Jun. 24, 2004

(54) Planetary transmission

(76) Inventors: Horst Schulz, Friedrichshafen (DE); Tin Kirschner, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/731,051

(22) Filed: Dec. 9, 2003

(30) Foreign Application Priority Data
Dec. 14, 2002 (DE) 102 58 515.6

(51) Int. Cl. F16H 57/08

(52) U.S. Cl. 475/331

(57) ABSTRACT

A planetary transmission comprising one sun gear (3) actuatable by one input shaft (2), one ring gear (15) connected with a housing (14), a group of planetary gears (22) and a group of step planets (4) with large and small step gears (5, 6). The planetary gears (22) and the step planets (4) are supported in a common planet carrier and are engaged both with each other and also with the sun gear (3) and the ring gear (15). The planet carrier is supported opposite the housing (14) via a cross roller bearing (12) with a preferably split inner ring (13, 13a, 13b) and is designed at least in two parts (8, 9), a partition line (10) extending preferably in a radial plane.

The invention relates to a planetary transmission according to claim 1 and to the object of the applicant's older patent application having file reference 102 35 280.

The planetary transmission according to the applicant's older patent application has a one-piece planet carrier supported opposite to a housing via a cross roller bearing with a split inner ring. The inner ring supports itself on a collar of the planet carrier and is axially fixed by separate retaining means, that is, it is pressed against the collar of the planet carrier. Such an additional retaining component, which consists of individual fingers and does not abut on the entire periphery of the inner ring, does not produce any uniform and sufficiently fixed support of the inner ring. Besides, such a solution appears to be costly.

The problem on which the invention is based is to obtain an improved suport and axial fixing of the cross roller bearing at low cost for a planetary transmission of the kind mentioned above.

Said problem is solved by the characteristic features of claim 1. The division of the planet carrier achieves as advantage that the supporting means for the inner ring, particularly a split inner ring, can be integrated in the planet carrier. Thus, no additional retaining means are required.

Advantageous developments of the invention result from the sub-claims. The planet carrier is thus divided in a radial plane so that two flatly mating “halves” result which are centered relative to each other and axially braced with each other by adequate means such as screw bolts. The two “halves” can be advantageously centered via fitting sleeves inserted in the through holes for the step planets. Thus no additional fitting holes are needed. It is further advantageous when both “halves” of the planet carrier form together a bearing seat for the inner ring of the cross roller bearing and each of them has one shoulder which impresses itself on the whole periphery of the inner ring. A stable axial fixing of the inner rings and of the cross roller bearing is thus obtained. The two-part planet carrier is advantageously constructed so that one “half” or the first part is designed as planet carrier proper, that is, as carrier of the planetary gears supported in the carrier by means of bolts. The other “half” or the second part forms the output of the planetary transmission and is therefore provided with an output flange, for example, for mounting an output shaft.

One embodiment of the invention which will be described in detail herebelow is shown in the drawing wherein:

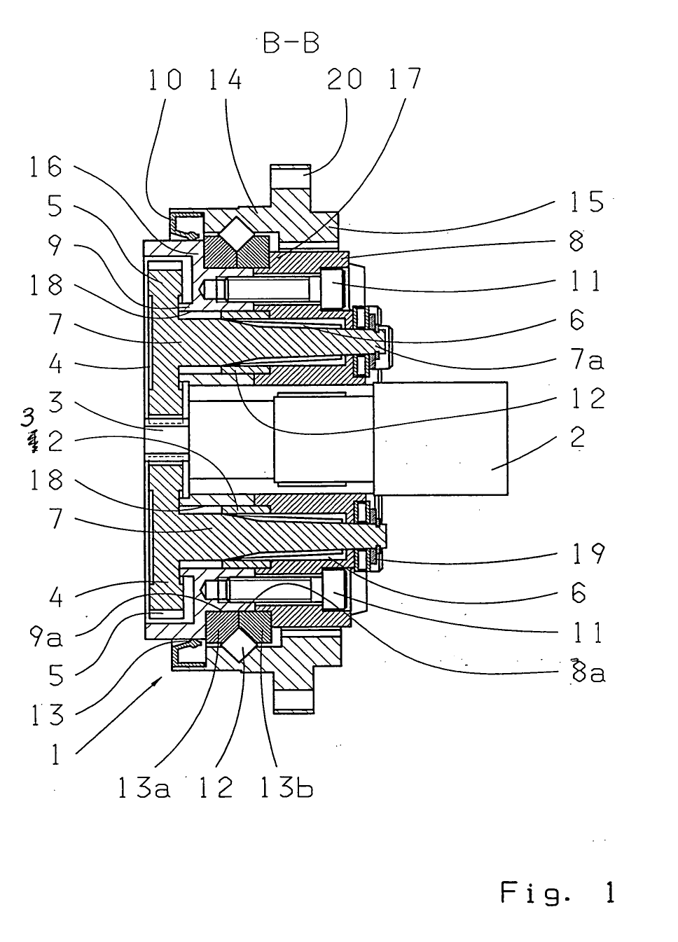

FIG. 1 is an axial section through a planetary transmission in the plane of the step planets;

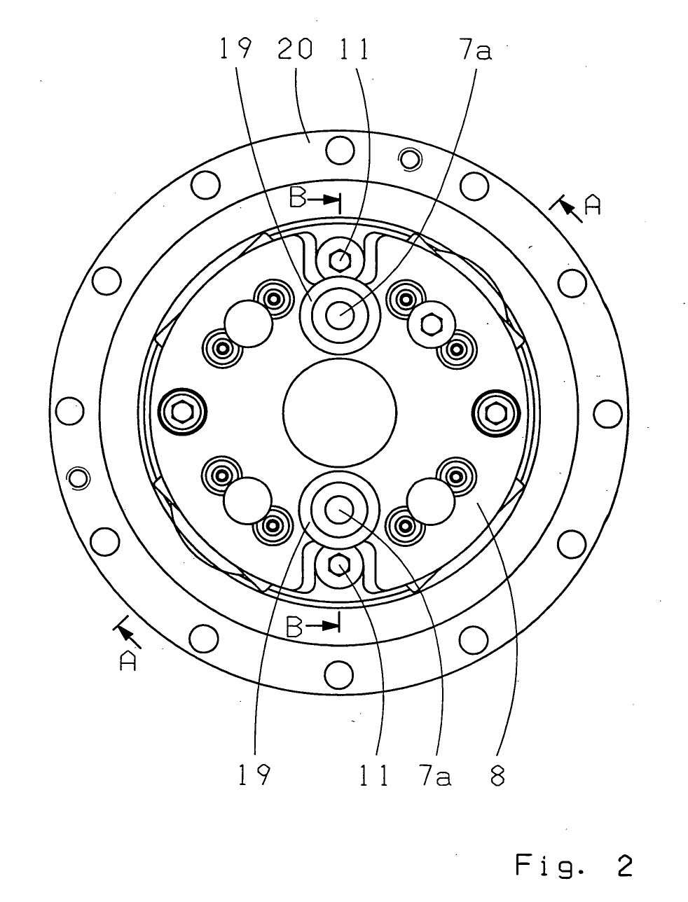

FIG. 2 is a view upon the planetary transmission in axial direction; and

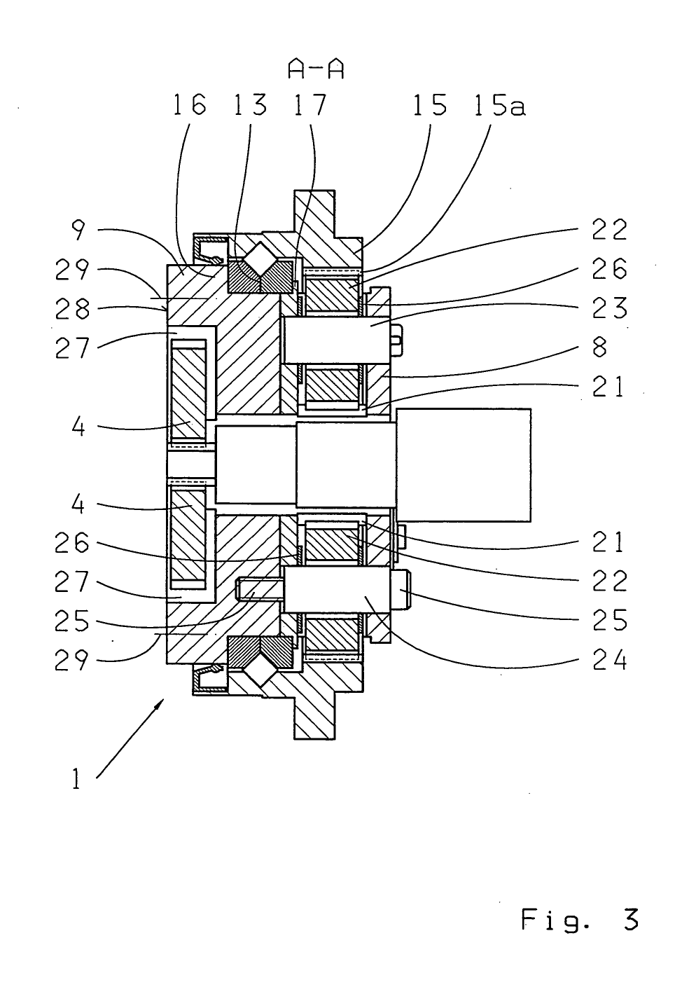

FIG. 3 is one other axial section through the planetary transmission in the plane of the planetary gears.

FIG. 1 shows an axial section through a planetary transmission 1 which is constructed similarly to the planetary transmission of the older patent application 102 35 280. The planetary transmission 1 is driven via an input shaft 2 which extends axially in the interior of the transmission and carries on its face and an inner sun gear 3 with conic toothing (not shown). The sun gear 3 is engaged with two step gear 6 or pinion also with conic toothing. A step gear 5 and the pinion 6 are interconnected by an intermediate shaft 7. A planet carrier made of two parts or “halves” to wit, a first part 8 situated to the right in the drawing and a second part 9 situated to the left in the drawing. Said two parts 8, 9 are in the area of a partition line 10 flatly joined together and are axially braced with each other by screw bolt 11. Both parts 8, 9 are also centered with each other via fitting sleeves 12. Between the two parts 8, 9 is clamped a cross roller bearing 12 having an inner ring 13 which is split and comprises two inner ring halves 13a, 13b. Via the cross roller bearing 12, the planet carrier 8, 9 is supported opposite a housing 14. With the housing 14 is connected a ring gear 15 having an inner toothing. The planet carrier part 9 on the output side has, in the area of the inner ring 13, one shoulder 16 and the planet carrier part 8 on the input side has an oppositely oriented shoulder 17. Between both shoulders 16, 17, the two parts 9, 8 form each a bearing seat 9a, 8a which serves to accommodate the two inner rings 13a, 13b. The cross roller bearing 12 or both inner rings 13a, 13b are therefore assembled before the junction of both parts 8, 9 of the planet carrier. Both inner rings 13a, 13b are precisely adjusted or braced on one side via the screw bolts 11, and on the other side, via washers (not shown here), between the inner rings 13a, 13b and/or the shoulders 16, 17. Thereby a minimal gap results in the area of the parting line 10. The torque between both parts 8, 9 is transmitted on one side by the non-positive engagement produced as result of the prestress of the screw bolts 11 and on the other side by positive engagement as consequence of the fitting sleeves 12. The step planets 4 are supported via intermediate shafts 7 in bearing holes 18 of the output-side part 9. In the area of said bearing hole 18 are also inserted the already mentioned fitting sleeves 12 which extend beyond the partition line 10 into the first part 8. The intermediate shaft 7 continues via the pinion 6 into a bearing stud 7a which is supported in the part 8 and is fixed by an adjusting device 19 in its precise axial position. The housing 14 has a fastening flange 20 with which the whole planetary transmission 1 can be screwed on a motor (not shown) which, at the same time, has the input shaft 2. To that extent it is possible to omit a bearing of the planet carrier part 8 opposite the input shaft 2.

FIG. 2 shows a front face of the planetary transmission view in FIG. 1, that is, in axial direction, upon the planetary transmission 1 with the fastening flange 20 and the planet carrier part 8, the same as the screw bolts 11 thereof. In the axial plane (extending vertically in the drawing) in which the screw bolts 11 are located, lie also the bearing studs 7a of the step planets 4 which are axially adjusted by the adjusting device 19, for example, adjusting threads. Said axial plane is designated with B-B and corresponds to the sectional plane of FIG. 1.

FIG. 3 shows one other axial section through the planetary transmission 1 and this along the sectional plane A-A marked in FIG. 2. The first part 8 of the planet carrier has two pockets diametrically opposite in which are situated planetary gears 22 supported via bolts 23, 24 in the part 8. The bolt 24 is designed as a sleeve and incorporates a screw bolt 25 for axial bracing of both parts 8, 9 of the planet carrier. The planetary gears 2 mesh with the ring gear 15 which has a conical inner toothing 15a which is engaged with a corresponding conical toothing of the planetary gears 22. To the end of adjustment of a defined toothing play, the planetary gears 22 are individually axially lined via an adjusting thread (not shown). For this adjusting path, the width of pockets 21 is larger than the width of the planetary gears 22. A special washer 26 can transmit the counterpressure of the adjusting thread to the associated planets 22. It is understood in this sectional illustration that both shoulders 16, 17 are rotary and thus exert a uniform counterpressure upon the inner ring 13. The output-side part 9 of the planet carrier has two recesses 27 on its outer end face adapted to the step planets 4. Outside said recesses 27 is disposed an end-face output flange 28 having fastening holes indicated by center lines 29. To said output flange 28 can be attached one output shaft (not shown), for example.

Reference Numerals

1 planetary transmission

2 input shaft

3 sun gear

4 step planet

5 large step gear

6 small step gear (pinion)

7 intermediate shaft

7a bearing stud

8 first part (planet carrier)

8a bearing seat

9 second part (planet carrier)

9a bearing seat

10 parting line

11 screw bolt

12 cross roller bearing

13 inner ring

13a inner ring half

13b inner ring half

14 housing

15 ring gear

15a inner toothing

16 should (part 9)

17 shoulder (part 8)

18 bearing hole

19 adusting device

20 fastening flange

21 pocket in planet carrier

22 planetary gear

23 planetary bolt

24 sleeve

25 screw bolt

26 washer

27 recess

28 output flange

29 fastening hole

1. Planetary transmission (1) having one sun gear (3) actuatable by an input shaft (2) one ring gear (15) connected with a housing (14) one group of planetary gears (22) and one group of step planets (4) with large and small step gears (5, 6)
wherein said planetary gears (22) and said step planets (4) are supported in a common planet carrier and engaged both with each other the same as with said sun gear (3) and said ring gear (15),
wherein said planet carrier has one output flange supported opposite said housing (14) via one cross roller bearing (12) with preferably split inner rings (13, 13a, 13b) and designed in at least two parts (8, 9).

2. Planetary transmission according to claim 1, characterized in that said planet carrier has at least one parting line (10) extending in a radial plane.

3. Planetary transmission according to claim 2, characterized in that said parting line (10) is situated in the area of the axial extension of said inner ring (13) or said split inner ring (13a, 13b).

4. Planetary transmission according to claim 1, 2 or 3, characterized in that said planet carrier is composed of one first and one second part (8, 9) which are centered and axially braced relative to each other.

5. Planetary transmission according to claim 4, characterized in that said parts (8, 9) are braced with each other via screw bolts (11).

6. Planetary transmission according to claim 4 or 5, characterized in that said parts (8, 9) are centered via fitting sleeves (12).

7. Planetary transmission according to claim 6, characterized in that said fitting sleeves (12) are inserted in bearing holes for the step planets (4, 7).

8. Planetary transmission according to claim 4, 5 6 or 7, characterized in that said first and said second part (8, 9) have each one shoulder (17, 16) respectively for supporting said inner ring (13) and said split inner ring (1 3a, 13b) and for axial fixing of said cross roller bearing (12).

9. Planetary transmission according to any one of claims 4 to 8, characterized in that said first and said second part (8, 9) form in the area of said parting line (10) a common bearing seat (8a, 9a) for said inner ring (13) or said split inner ring (13a, 13b).

10. Planetary transmission according to any one of claims 4 to 8, characterized in that only one of said two parts (8, 9) has a bearing seat respectively for said inner ring (13) and said split inner ring (13a, 13b).

11. Planetary transmission according to any one of claims 4 to 10, characterized in that said first part (8) is designed as carrier of said planetary gears (22) by means of planetary bolts (23) and said second part (9) is designed as output part with one output flange (28).
